(19) United States
(12) Patent Application Publication
(10) Pub. No.: US 2025/0013207 A1
(43) Pub. Date: Jan. 9, 2025

(54) CROWN FOR AN ELECTRONIC WATCH

(71) Applicant: Apple Inc., Cupertino, CA (US)

(72) Inventors: Ryan C. Perkins, San Francisco, CA (US); Maegan K. Spencer, Emerald Hills, CA (US); Brad G. Boozer, Saratoga, CA (US)

(21) Appl. No.: 18/889,212

(22) Filed: Sep. 18, 2024

Related U.S. Application Data
(63) Continuation of application No. 18/232,660, filed on Aug. 10, 2023, now Pat. No. 12,105,480.
Application No. 18/232,660 is a continuation of application No. 17/838,247, filed on Jun. 12, 2022, now Pat. No. 11,754,981.
Application No. 17/838,247 is a continuation of application No. 16/408,774, filed on May 10, 2019, now Pat. No. 11,360,440.
(60) Provisional application No. 62/689,775, filed on Jun. 25, 2018.

(51) Int. Cl. G04G 21/08; G01D 5/347

(52) U.S. Cl. CPC G04G 21/08; G01D 5/3473

(57) ABSTRACT

An electronic watch includes a housing, a display positioned at least partially within the housing, a cover covering at least part of the display, and a crown having a portion positioned along a side of the housing. The crown may include an inner member that is rotationally constrained relative to the housing and an outer member that is rotationally free relative to the inner member. The device may further include a rotation sensor configured to sense a rotation of the outer member relative to the inner member.

### CROSS-REFERENCE TO RELATED APPLICATIONS

This application is a continuation of U.S. patent application Ser. No. 18/232,660, titled “Crown for an Electronic Watch,” filed Aug. 10, 2023, which is a continuation of U.S. patent application Ser. No. 17/838,247, titled “Crown for an Electronic Watch,” filed Jun. 12, 2022, and issued as U.S. Pat. No. 11,754,981 on Sep. 12, 2023, which is a continuation of U.S. patent application Ser. No. 16/408,774, titled “Crown for an Electronic Watch,” filed May 10, 2019, and issued as U.S. Pat. No. 11,360,440 on Jun. 14, 2022, which is a non-provisional patent application of and claims the benefit of U.S. Provisional Patent Application No. 62/689,775, titled “Crown for an Electronic Watch,” filed Jun. 25, 2018, the disclosure of which are hereby all incorporated herein by reference in their entireties.

### FIELD

The described embodiments relate generally to electronic devices, and more particularly to a crown for a wearable electronic device.

### BACKGROUND

Electronic devices frequently use physical input devices to facilitate user interaction. For example, buttons, keys, dials, and the like, can be physically manipulated by users to control operations of the device. Physical input devices may use various types of sensing mechanisms to translate the physical manipulation to signals usable by the electronic device. For example, buttons and keys may use collapsible dome switches to detect presses, while dials and other rotating input devices may use encoders or resolvers to detect rotational movements.

### SUMMARY

An electronic watch includes a housing, a display positioned at least partially within the housing, a cover covering at least part of the display, and a crown having a portion positioned along a side of the housing. The crown may include an inner member that is rotationally constrained relative to the housing and an outer member that is rotationally free relative to the inner member. The device may further include a rotation sensor configured to sense a rotation of the outer member relative to the inner member. The housing may define an interior volume, the inner member may define an exterior portion, the exterior portion of the inner member may define a circular peripheral surface, the outer member may be coupled to the exterior portion of the inner member and configured to rotate along the circular peripheral surface, and the outer member is positioned outside the interior volume such that the rotation of the outer member occurs outside the interior volume. The rotation sensor may be at least partially within the inner member of the crown.

The housing may define an interior volume and an opening extending from the interior volume to an exterior environment of the housing. The rotation sensor may be configured to sense the rotation of the outer member via the opening. The rotation sensor may be an optical sensor, the electronic watch may further include an optically transmissive window covering at least part of the opening, and the rotation sensor may sense the rotation of the outer member through the optically transmissive window.

The electronic watch may further include a force sensing component positioned at least partially within the housing and configured to detect an axial force applied to the crown. The force sensing component may include a dome switch. The rotation sensor may be a Hall effect sensor. The rotation sensor may include a light detector and a light emitter configured to emit light toward the outer member of the crown. The light detector may detect the light after the light is reflected by the outer member of the crown.

A wearable electronic device may include a housing, a display positioned at least partially within the housing, a cover covering at least part of the display and defining a front face of the wearable electronic device, a crown positioned along a side of the housing and rotationally constrained relative to the housing, and a sensor configured to sense a movement of a finger as the finger is sliding along a surface of the crown. The crown may be rotationally fixed. A sensing element of the sensor may be positioned at least partially within the crown.

The crown may define a first portion of a surface, and the crown may include a protective cover covering the sensing element and defining a second portion of the surface. The sensing element may be an optical sensing element, and the protective cover is an optically transmissive window.

The display may define an output region. The cover may define an input surface that covers the output region and the sensor may be a touch sensor that extends along the output region and is configured to detect touch inputs applied to the input surface and to sense the movement of the finger sliding along the surface of the crown.

The housing may define an interior volume and an opening extending from the interior volume to an exterior of the housing, and the sensor may be configured to sense the movement of the finger through the opening.

A wearable electronic device may include a housing defining a side surface of the electronic device, a transparent cover coupled to the housing and defining a front surface of the wearable electronic device, a crown extending from the side surface and rotationally constrained relative to the housing, and a sensor configured to sense a movement of a finger sliding along a surface of the crown.

A wearable electronic device may include a housing, a display positioned at least partially within the housing, a cover covering at least part of the display and defining a front face of the wearable electronic device, and a crown positioned along a side of the housing. The crown may include an inner member that is rotationally constrained relative to the housing and an outer member that is rotationally free relative to the inner member. The wearable electronic device may further include a sensor configured to sense movement of a finger while the finger is rotating the outer member. The inner member may define a cylindrical surface, and the outer member may be a sleeve positioned around the cylindrical surface. The sensor may be positioned along a side of the housing.

The wearable electronic device may further include an actuator coupled to the crown and configured to produce a tactile output through the crown. The wearable electronic device may further include a force sensor configured to detect an axial force applied to the crown. The force sensor may determine a magnitude of the axial force and the wearable electronic device may cause the actuator to produce the tactile output if the magnitude of the axial force is greater than a threshold value.

A wearable electronic device may include a housing, a crown extending from a side of the housing and comprising a rotationally fixed first member and a rotationally free second member coupled to the rotationally fixed first member, and a sensor positioned on the housing and configured to sense movement of a finger while the finger is rotating the rotationally free second member of the crown.

### BRIEF DESCRIPTION OF THE DRAWINGS

The disclosure will be readily understood by the following detailed description in conjunction with the accompanying drawings, wherein like reference numerals designate like structural elements, and in which:

FIGS. 1A-1B depict a wearable electronic device;

FIGS. 2A-2B depict another wearable electronic device being used;

FIGS. 3A-3B depict another wearable electronic device being used;

FIGS. 4A-4B are partial cross-sectional views of an example wearable electronic device having a crown with a rotatable member and a sensor for sensing rotation of the rotatable member;

FIG. 5 is a partial cross-sectional view of another example wearable device having a crown with a rotatable member and a sensor for sensing rotation of the rotatable member;

FIG. 6 is a partial cross-sectional view of an example wearable device having a crown with a rotationally constrained member and a sensor for sensing motion of a user's finger;

FIG. 7 is a partial cross-sectional view of another example wearable device having a crown with a rotationally constrained member and a sensor for sensing motion of a user's finger;

FIG. 8 is a partial cross-sectional view of an example wearable device having a crown with a rotatable member and a sensor for sensing motion of a user's finger;

FIG. 9 is a partial cross-sectional view of an example wearable electronic device having a crown with a rotatable member and a sensor for sensing rotation of the rotatable member;

FIG. 10 is partial cross-sectional view of another example wearable electronic device having a crown with a rotatable member and a sensor for sensing rotation of the rotatable member;

FIGS. 11A-11D depict example sensors for sensing user interactions with a crown; and

FIG. 12 depicts example components of a wearable electronic device.

### DETAILED DESCRIPTION

Reference will now be made in detail to representative embodiments illustrated in the accompanying drawings. It should be understood that the following description is not intended to limit the embodiments to one preferred embodiment. To the contrary, it is intended to cover alternatives, modifications, and equivalents as can be included within the spirit and scope of the described embodiments as defined by the appended claims.

The embodiments herein are generally directed to a crown of a wearable electronic device, such as a smart watch, and more particularly to a crown that includes a non-rotating (or rotationally constrained) component, yet is still able to detect when a user is interacting with the crown in a conventional manner. For example, a crown of a smart watch may be rotationally fixed relative to a housing such that, if a user attempts to rotate the crown to operate the device, the crown does not physically rotate. Instead, the user's fingers may slide along a surface of the crown while the crown remains stationary. The device may detect the movement of the user's fingers as they slide over the surface of the crown rather than sensing rotation of the crown. As used herein, a finger or object “sliding” along a surface may refer to the finger (or other object) moving along the surface while the finger (or other object) is in contact with the surface.

Using a rotationally fixed crown instead of a freely rotating crown may result in more robust and reliable devices. For example, a freely rotatable crown may include a shaft that extends through an opening in a housing so that the rotation of the shaft can be detected by an internal sensor, or so that the shaft can drive an internal gear train. However, the bearings, bushings, and other mechanisms that allow the shaft to rotate freely with respect to the housing of the device may allow water, sweat, lotion, sunscreen, dust, dirt, and other contaminants to clog the mechanism or to enter into the housing, potentially damaging the device. Further, rotating components may wear out over time, requiring repair or replacement or otherwise reducing the usability of the device. By eliminating the rotating shaft, a more robust and reliable crown may be provided. However, because the user can still interact with a rotationally fixed crown in a similar way to a conventional rotating crown (e.g., by attempting to rotate the crown with a finger), the rotationally fixed crown may still provide a familiar and intuitive input mechanism with which a user can control the device.

Many of the same benefits may be realized with crowns that include some rotatable components. For example, a crown may be configured with a rotationally fixed member and a rotationally free member, where the rotationally free member does not extend into the housing of the device. For example, the rotationally free member may be a sleeve that is free to rotate around a portion of a rotationally fixed shaft. A sensor may detect the rotation of the sleeve, while the rotationally fixed shaft (which may extend into the housing) does not rotate, and thus the crown can be more effectively sealed against liquids and contaminants. In some cases, even crowns with freely rotatable shafts may experience similar benefits by limiting or reducing the distance that the freely rotatable shaft translates when pushed. Examples of crowns having these, and other configurations are described in more detail herein.

As described above, the crown may be rotationally fixed and still allow the detection of rotational-style inputs on the crown (e.g., gestures that would produce a rotation on a conventional rotatable crown). However, in some cases, instead of being rotationally fixed, the crown (or a member or component of a crown) may be partially rotatable. More particularly, a partially rotatable crown may allow limited rotational motion while still being largely rotationally constrained. For example, a partially rotatable crown may allow a small amount of rotation (e.g., less than one degree, one degree, five degrees, ten degrees, etc.), after which the crown is prevented from rotating further. This relatively small amount of free rotation may facilitate several functions, such as allowing the crown to sense an amount of force or torque being applied to the crown, or to allow the crown to move to provide haptic outputs to a user. As used herein, a “rotationally constrained” component refers to a component that is not free to rotate more than a full revolution under normal use conditions (e.g., when manipulated by the hands of a person). Thus, rotationally constrained components include both rotationally fixed components and partially rotatable components.

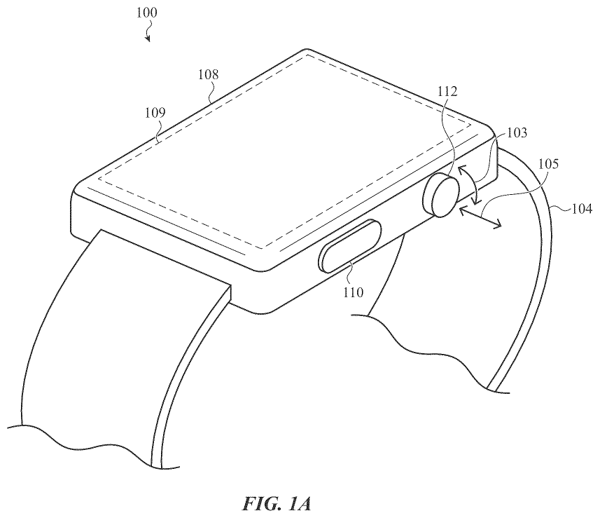

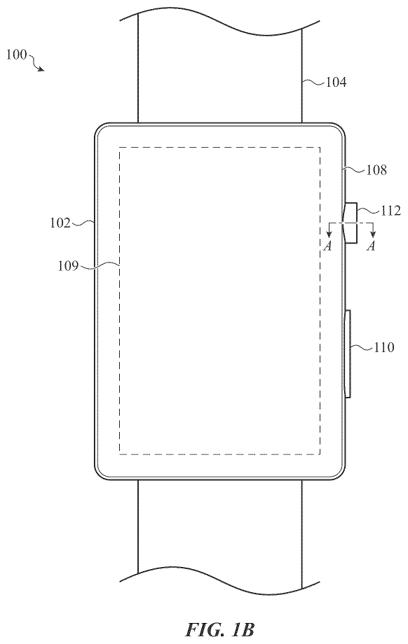

FIGS. 1A-1B depict an electronic device 100. The electronic device 100 is depicted as a watch (e.g., an electronic watch), though this is merely one example embodiment of an electronic device and the concepts discussed herein may apply equally or by analogy to other electronic devices, including mobile phones (e.g., smartphones), tablet computers, notebook computers, head-mounted displays, digital media players (e.g., mp3 players), or the like.

The electronic device 100 includes a housing 102 and a band 104 coupled to the housing. The band 104 may be configured to attach the electronic device 100 to a user, such as to the user's arm or wrist.

The electronic device 100 also includes a transparent cover 108 coupled to the housing 102. The cover 108 may define a front face of the electronic device 100. For example, in some cases, the cover 108 defines substantially the entire front face and/or front surface of the electronic device. The cover 108 may also define an input surface of the device 100. For example, as described herein, the device 100 may include touch and/or force sensors that detect inputs applied to the cover 108. The cover may be formed from or include glass, sapphire, a polymer, a dielectric, or any other suitable material.

The cover 108 may overlie at least part of a display 109 that is positioned at least partially within the housing 102. The display 109 may define an output region in which graphical outputs are displayed. Graphical outputs may include graphical user interfaces, user interface elements (e.g., buttons, sliders, etc.), text, lists, photographs, videos, or the like. The display 109 may include a liquid crystal display (LCD), organic light emitting diode display (OLED), or any other suitable components or display technology.

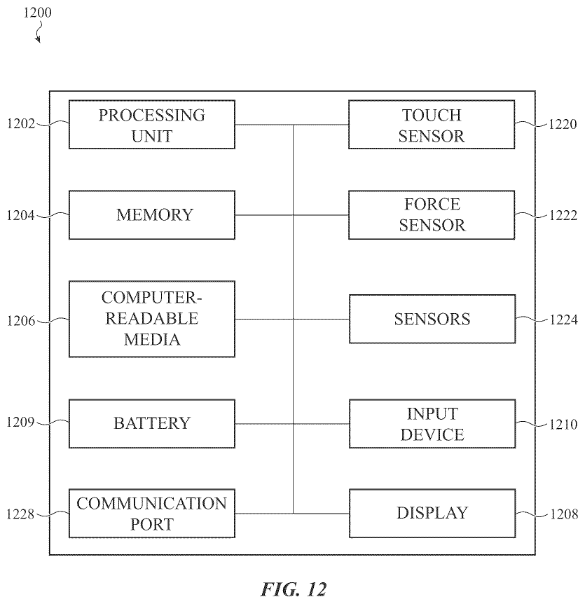

The display 109 may include or be associated with touch sensors and/or force sensors that extend along the output region of the display and that may use any suitable sensing elements and/or sensing techniques. Using touch sensors, the device 100 may detect touch inputs applied to the cover 108, including detecting locations of touch inputs, motions of touch inputs (e.g., the speed, direction, or other parameters of a gesture applied to the cover 108), or the like. Using force sensors, the device 100 may detect amounts or magnitudes of force associated with touch events applied to the cover 108. The touch and/or force sensors may detect various types of user inputs to control or modify the operation of the device, including taps, swipes, multi-finger inputs, single- or multi-finger touch gestures, presses, and the like. Further, as described herein, the touch and/or force sensors may detect motion of an object (e.g., a user's finger) as it is interacting with a crown 112 of the electronic device 100. Touch and/or force sensors usable with wearable electronic devices, such as the device 100, are described herein with respect to FIG. 12.

The electronic device 100 also includes a crown 112 having a knob, protruding portion, or component(s) or feature(s) positioned along a side of the housing 102. At least a portion of the crown 112 may protrude from the housing 102, and may define a generally circular shape or a circular exterior surface. The exterior surface of the crown 112 may be textured, knurled, grooved, or may otherwise have features that may improve the tactile feel of the crown 112 and/or facilitate rotation sensing.

The crown 112 may afford a variety of potential user interactions. For example, the crown 112 may include a rotationally free member that is free to rotate relative to a rotationally fixed member of the crown 112. More particularly, the rotationally free member may have no rotational constraints, and thus may be capable of being rotated indefinitely. In such cases, the device may include sensors that detect the rotation of the rotationally free member. Rotation sensors may be integrated with the crown 112 itself, or they may be integrated with the housing 102, the cover 108, the display 109, or another component of the device 100.

In some cases, the crown 112 may be rotationally constrained (e.g., rotationally fixed or partially rotatable), and may include or be associated with sensors that detect when a user slides one or more fingers along a surface of the crown 112 in a movement that resembles rotating the crown 112 (or that would result in rotation of a freely rotating crown). More particularly, where the crown 112 is rotationally fixed or rotationally constrained, a user input that resembles a twisting or rotating motion may not actually result in any substantial physical rotation that can be detected for the purposes of registering an input. Rather, the user's fingers (or other object) will result in a movement that resembles twisting, turning, or rotating, but does not actually continuously rotate the crown 112. Thus, in the case of a rotationally fixed or constrained crown 112, sensors may detect gestures that result from the application of an input that has the same motion as (and thus may feel and look the same as or similar to) rotating a rotatable crown. The sensors that detect such gestures may be on or near the crown 112.

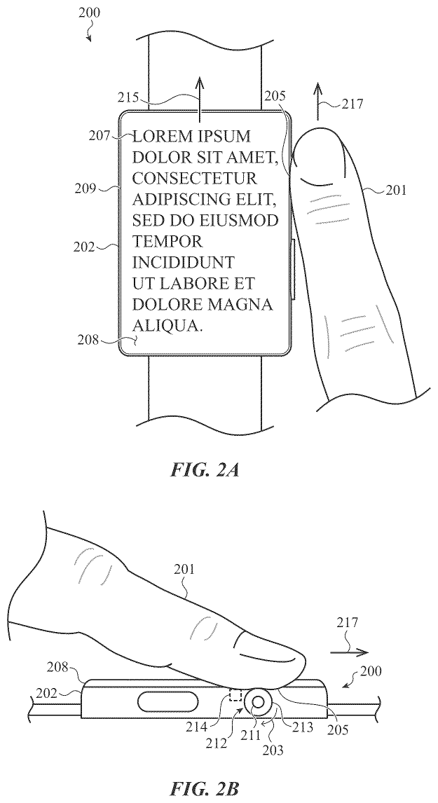

The particular gestures that are detected may depend at least in part on the types and/or locations of sensors in the device 100. For example, a user attempting to rotate a rotationally fixed crown 112 by pinching and twisting may result in a sliding gesture along the surface of the crown 112, and an optical sensor may sense the movement of the user's finger(s) along the surface. As another example, a user attempting to rotate a rotationally fixed crown by applying a substantially tangential force to a surface of the crown 112 (as shown in FIGS. 2A-2B, for example) may also result in a sliding gesture along a surface of the crown 112. The user's finger may also be in contact with a surface of the housing 102 and/or the cover 108 during these gestures, and as such the user's finger may slide along a surface of the housing 102 and/or the cover 108 in addition to a surface of the crown 112. As described herein, this may allow the device to detect the motion of the finger from various locations or positions on the device 100.

In cases where the crown 112, or a member or component of the crown 112, is capable of some rotation, it may rotate about a rotation axis (e.g., it may rotate as indicated by arrow 103 in FIG. 1A). The crown 112, or a member or component of the crown 112, may also be translatable relative to the housing 102 to accept axial inputs. For example, the crown 112 may be movable or translatable along the rotation axis, towards and/or away from the housing 102, as indicated by arrow 105 in FIG. 1A. The crown 112 may therefore be manipulated by pushing and/or pulling on the crown 112.

The crown 112 may be able to translate any suitable distance. For example, a crown 112 may include a dome switch to register axial inputs, and the crown 112 may move a sufficient distance to facilitate physical actuation of the dome switch. In other cases, such as where a force sensor is used to detect axial inputs, the crown 112 may move a sufficient distance to facilitate force sensing. The distance that the crown 112 can translate or move may be any suitable distance, such as about 1 mm, 0.5 mm, 0.2 mm, 0.1 mm, 0.05 mm or any other suitable distance.

The device 100 may include a force sensor to detect axial forces that are applied to the crown 112. The force sensor may include or use any suitable force sensing components and may use any suitable technique for sensing force inputs. For example, a force sensor may include a strain sensor, capacitive gap sensor, or other force sensitive structure that is configured to produce an electrical response that corresponds to an amount of force (e.g., axial force) applied to the crown 112. The electrical response may increase continuously as the amount of applied force increases, and as such may provide non-binary force sensing. Accordingly, the force sensor may determine, based on the electrical response of the force sensing components, one or more properties of the applied force associated with a touch input (e.g., a magnitude of the applied axial force).

As described herein, rotational inputs, gesture inputs (e.g., rotational-style inputs applied to a rotationally fixed crown), and axial inputs (e.g., translations or axial forces) may control various operations and user interfaces of the electronic device 100. In particular, inputs to the crown 112 may modify the graphical output of the display 109. For example, a rotational movement of the crown 112 or a gesture applied to the crown 112 may zoom, scroll, or rotate a user interface or other object displayed on the display 109 (among other possible functions), while translational movements or axial inputs may select highlighted objects or icons, or activate or deactivate functions (among other possible functions).

The crown 112 may also be associated with or include a contact sensor that is configured to detect contact between a user and the crown 112 (e.g., touch inputs or touch events applied to the crown 112). The contact sensor may detect even non-moving contacts between the user and the crown 112 (e.g., when the user touches the crown 112 but does not rotate the crown or apply a sliding gesture to the crown 112). Contact sensing functionality may be provided by a touch sensor that also detects gestures (e.g., a finger sliding along a surface of a crown or the housing), or it may be provided by a separate sensor. The contact sensor may include or use any suitable type of sensor(s), including capacitive sensors, resistive sensors, magnetic sensors, inductive sensors, or the like. In some cases, the crown 112 itself, or components of the crown, may be conductive and may define a conductive path between the user (e.g., the user's finger) and a contact sensor. For example, the crown may be formed from or include metal, and may itself act as an electrode for conductively coupling a capacitive sensor to the user.

The device 100 may also include one or more haptic actuators that are configured to produce a tactile output through the crown 112. For example, the haptic actuator may be coupled to the crown 112 and may be configured to impart a force to the crown 112. The force may cause the crown 112 to move (e.g., to oscillate or vibrate translationally and/or rotationally, or to otherwise move to produce a tactile output), which may be detectable by a user when the user is contacting the crown 112. The haptic actuator may produce tactile output by moving the crown 112 in any suitable way. For example, the crown 112 (or a component thereof) may be rotated (e.g., rotated in a single direction, rotationally oscillated, or the like), translated (e.g., moved along a single axis), or pivoted (e.g., rocked about a pivot point). In other cases, the haptic actuator may produce tactile outputs using other techniques, such as by imparting a force to the housing 102 (e.g., to produce an oscillation, vibration, impulse, or other motion), which may be perceptible to a user through the crown 112 and/or through other surfaces of the device 100, such as the cover 108, the housing 102, or the like. Any suitable type of haptic actuator and/or technique for producing tactile output may be used to produce these or other types of tactile outputs, including electrostatics, piezoelectric actuators, oscillating or rotating masses, ultrasonic actuators, reluctance force actuators, voice coil motors, Lorentz force actuators, or the like.

Tactile outputs may be used for various purposes. For example, tactile outputs may be produced when a user presses the crown 112 (e.g., applies an axial force to the crown 112) to indicate that the device 100 has registered the press as an input to the device 100. As another example, tactile outputs may be used to provide feedback when the device 100 detects a rotation of the crown 112 or a gesture being applied to the crown 112. For example, a tactile output may produce a repetitive “click” sensation as the user rotates the crown 112 or applies a gesture to the crown 112. Tactile outputs may be used for other purposes as well.

The electronic device 100 may also include other inputs, switches, buttons, or the like. For example, the electronic device 100 includes a button 110. The button 110 may be a movable button (as depicted) or a touch-sensitive region of the housing 102. The button 110 may control various aspects of the electronic device 100. For example, the button 110 may be used to select icons, items, or other objects displayed on the display 109, to activate or deactivate functions (e.g., to silence an alarm or alert), or the like.

FIGS. 2A-2B show a front and side view, respectively, of a device 200 during one example use condition. The device 200 may be an embodiment of the device 100, and may include the same or similar components and may provide the same or similar functions as the device 100. Accordingly, details of the device 100 described above may apply to the device 200, and for brevity will not be repeated here.

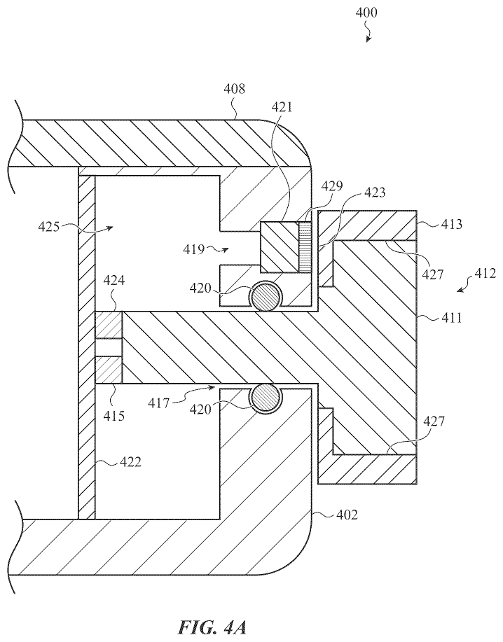

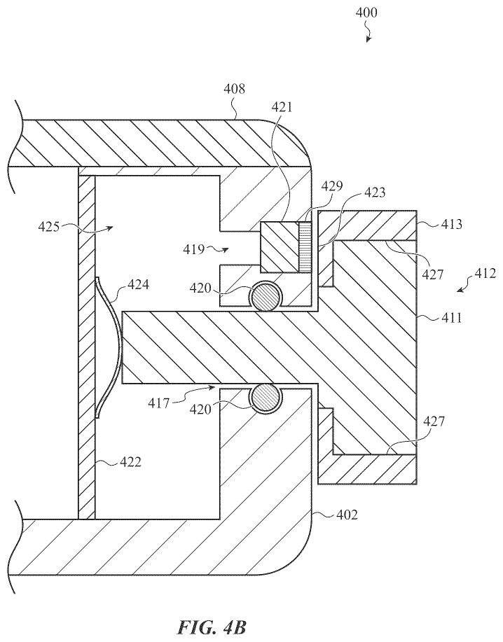

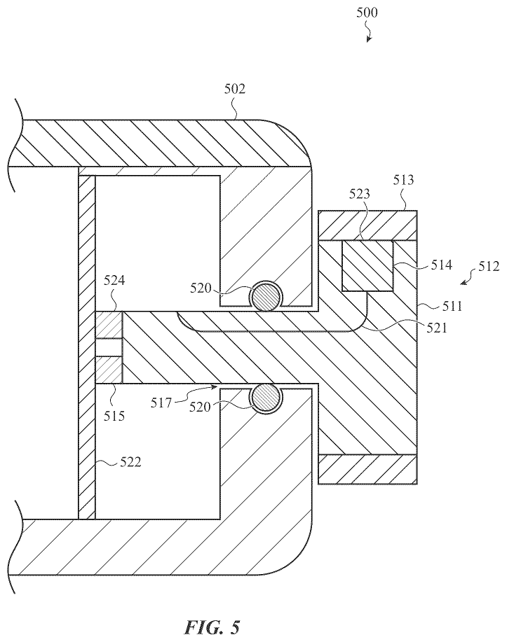

In the example shown in FIGS. 2A-2B, the wearable device 200 includes a crown 212 that a user may contact to provide input through the crown 212. The crown 212 may include a rotationally constrained inner member 211 and a rotationally free outer member 213. The device 200 may also include a rotation sensing element 214 (FIG. 2B) that is configured to detect rotation of the rotationally free outer member 213. The positioning of the rotation sensing element 214 in FIG. 2B is merely for illustration, and it may be positioned elsewhere in the device 200 as described in greater detail herein with respect to FIGS. 4A-10. For example, the rotation sensing element may be positioned in the housing 202 or in the crown 212. In some cases, the rotation sensing element 214 may be configured to detect the motion of a user's finger 201 (or other object) that is rotating the rotationally free outer member 213, instead of or in addition to detecting the rotation of the rotationally free outer member 213.

FIGS. 2A-2B show a user manipulating the crown 212 to provide an input to the device 200. More particularly, a user's finger 201 is in contact with the rotationally free outer member 213 (also referred to herein for simplicity as an outer member) and is moving along a direction indicated by arrow 217. The force applied to the outer member 213 by the user's finger 201 causes the outer member 213 to rotate relative to the rotationally constrained inner member 211 (also referred to herein for simplicity as an inner member). The rotation sensing element 214, in conjunction with other components of a rotation sensor, detects the rotation of the outer member 213 and causes the device 200 to take an action in response to the rotation. For example, as shown in FIG. 2A, upon detection of the outer member 213 rotating, the device 200 may cause a graphical output 207 on a display 209 to be moved in accordance with the rotation of the outer member 213. A rotation of the outer member 213 in the direction indicated by arrow 203 (FIG. 2B) may result in the graphical output 207 moving in the direction indicated by arrow 215 (FIG. 2A). A rotation of the outer member 213 in the opposite direction may result in the graphical output 207 moving in the opposite direction. The rotation of the outer member 213 may be used to change other operational properties of the device 200 in addition to or instead of scrolling a graphical output 207. For example, a rotation of the outer member 213 may change parameters or settings of the device, control a zoom level of a graphical output, change a time setting, or the like.

In some cases, instead of or in addition to a rotation sensing element 214, the device 200 includes a sensor that is configured to sense movement of a finger (or other implement or object) as the finger is rotating the outer member 213. In such cases, the rotation of the outer member 213 may not be directly sensed by the sensor, but instead may be used to provide the sensation of physical rotation to the user. In cases where the sensor is detecting motion of the user's finger rather than rotation of the outer member 213, a sensing element may be positioned so that it is proximate to the user's finger under normal or expected use conditions. For example, the sensing element may be positioned along a side of the device 200 where the user's finger is likely to contact the device 200 when rotating the outer member 213 (e.g., at location 205). In some cases, the sensing element may sense the motion of the user's finger through a cover 208 that covers the display 209. For example, the sensing element may include optical sensing elements and/or touch sensing elements that sense the motion of the user's finger 201 through the optically transmissive and/or dielectric material of the cover 208. In some cases, the device 200 may use the same touch sensor for detecting touch inputs applied to the cover 208 and for detecting motion of the user's finger as it rotates the outer member 213.

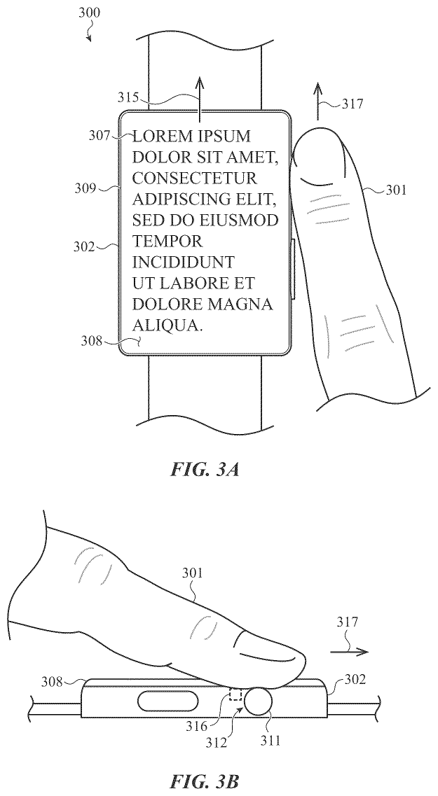

FIGS. 3A-3B show a front and side view, respectively, of a device 300 during one example use condition. The device 300 may be an embodiment of the device 100, and may include the same or similar components and may provide the same or similar functions as the device 100 (or the device 200). Accordingly, details of the devices 100, 200 described above may apply to the device 300, and for brevity will not be repeated here.

In the example shown in FIGS. 3A-3B, the wearable device 300 includes a crown 312 that may be rotationally constrained relative to a housing 302. For example, the housing 302 may be a monolithic structure that includes a protrusion, where the protrusion defines the crown 312. In some cases the crown 312 may be welded, adhered, bonded, or otherwise fixed to the housing 302. In cases where the crown 312 is rotationally constrained but partially rotatable, the crown 312 may be coupled to the housing 302 such that the crown 312 can rotate a small amount in response to input forces (e.g., from a user's finger) or output forces (e.g., from a haptic actuator), but does not fully or freely rotate.

The device 300 may also include a sensing element 316 (FIG. 3B) that is configured to sense a movement of the user's finger 301 as the finger 301 slides along a surface of the crown 312. The positioning of the sensing element 316 in FIG. 3B is merely for illustration, and it may be positioned elsewhere in the device 300 as described in greater detail herein with respect to FIGS. 4A-10. For example, the sensing element 316 may be positioned in the housing 302 or in the crown 312.

Because the crown 312 in FIGS. 3A-3B is rotationally constrained, it will not continuously rotate in response to the force applied by the finger 301 moving along the direction 317 (while the finger is in contact with the crown 312). Rather, the finger 301 will slide along a surface of the crown 312. Accordingly, the sensing element 316 detects the motion of the finger rather than a rotational motion of the crown 312.

The sensing element 316, in conjunction with other components of a sensor, detects the movement of the finger 301 sliding along a surface of the crown 312 (or along another surface of the device 300) and causes the device 300 to take an action in response to the rotation. For example, as shown in FIG. 3A, upon detection of the motion of the finger 301, the device 300 may cause a graphical output 307 on a display 309 to move in accordance with the movement of the finger 301. A movement of the finger 301 in the direction indicated by arrow 317 may result in the graphical output 307 moving in the direction indicated by arrow 315. A movement of the finger 301 in the opposite direction may result in the graphical output 307 moving in the opposite direction. Sliding a finger along a surface of the crown 312 may change other operational properties of the device 300 in addition to or instead of scrolling a graphical output 307. For example, sliding a finger along the surface of the crown 312 may change parameters or settings of the device, control a zoom level of a graphical output, rotate a displayed graphical output, translate a displayed graphical output, change a brightness level of a graphical output, change a time setting, scroll a list of displayed items (e.g., numbers, letters, words, images, icons, or other graphical output), or the like.

FIG. 4A is a partial cross section of an electronic device 400, corresponding to a view along line A-A in FIG. 1B. The device 400 may be an embodiment of the device 100, and may include the same or similar components and may provide the same or similar functions as the device 100 (or any other wearable device described herein). Accordingly, details of the wearable device 100 described above may apply to the device 400, and for brevity will not be repeated here.

The device 400 includes a crown 412 positioned along a side of a housing 402. The crown 412 may include an inner member 411 that is rotationally constrained relative to the housing 402, and an outer member 413 that is rotationally free relative to the inner member 411. As described above, the inner member 411 may be rotationally fixed relative to the housing 402, or it may be partially rotatable. The inner member 411 and outer member 413 may be formed from or include any materials, including metals (e.g., aluminum, alloys, magnesium, stainless steel, etc.), polymers, composites, glass, sapphire, or the like. In some cases, the inner and outer members 411, 413 are the same material, and in other cases they are different materials.

The inner member 411 may extend outwardly from the side of the housing 402 and may define a circular peripheral surface 427 on an exterior portion of the inner member. The outer member 413 may be coupled to the inner member 411 and may be configured to rotate along the circular peripheral surface 427. For example, the outer member 413 may rotate about an axis that extends through a center of the circle that corresponds to or is defined by the circular peripheral surface 427. Further, the circular peripheral surface 427 may be received in a circular opening defined in the outer member 413. In some cases, an inner surface of the circular opening may contact the circular peripheral surface 427, such that the inner surface slides along the circular peripheral surface 427 when the outer member 413 rotates along the circular peripheral surface 427. In other cases, the outer member 413 does not directly contact the circular peripheral surface 427 when the outer member 413 rotates along the circular peripheral surface 427. In either case, the crown 412 may include one or more bearings, bushings, or other components that facilitate rotation of the outer member 413 along the circular peripheral surface 427.

As described above, the outer member 413 may be outside of an interior volume 425 of the device 400, such that the rotation of the outer member 413 occurs outside of the interior volume 425 (such as exclusively outside of the interior volume, such that no portion of the outer member 413 extends into the interior volume or rotates within the interior volume). In some cases, such as where the inner member 411 is rotationally fixed relative to the housing 402, the outer member 413 may be the only component of the crown 412 that can rotate. Placing the rotating component(s) entirely outside of the interior volume may eliminate the need to have a rotating interface between a crown shaft and the housing 402, which may allow for simpler rotational mechanisms, better environmental seals between the crown and the housing, and the like.

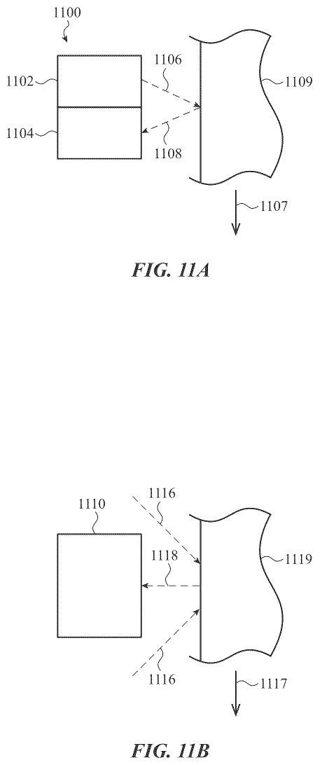

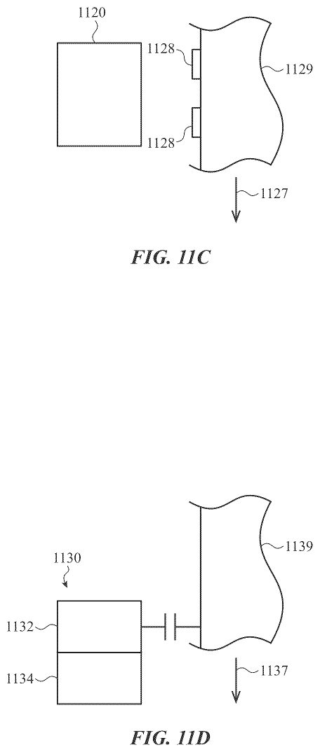

The device 400 may include a rotation sensing element 421 that, in conjunction with sensing circuitry and/or other components of a rotation sensor, senses a rotation of the outer member 413 relative to the inner member 411. The rotation sensing element 421 may use any suitable type of sensing technology or technique, including those described herein with respect to FIGS. 11A-11D. For example, the rotation sensing element 421 may be or may be part of a Hall effect sensor, an optical sensor (e.g., an encoder), a capacitive sensor, a resistive sensor, an inductive sensor, or any other suitable type of sensor. In some cases, the outer member 413 may have features or components that facilitate the rotation sensing by the rotation sensing element 421. For example, the outer member 413 may include magnets or ferromagnetic materials to facilitate rotation sensing by a Hall effect sensor, or a pattern of grooves or other features to facilitate rotation sensing by an optical sensor. Such features or components may be positioned along a side surface 423 of the outer member 413, or at any other position or location to facilitate sensing by the rotation sensing element 421.

The rotation sensing element 421 is configured to sense rotation of the outer member 413, which as noted above may be entirely outside of the interior volume 425 of the device 400. As shown in FIG. 4A, the rotation sensing element 421 is configured to detect or sense a side surface 423 of the outer member 413. The device may also include a protective cover 429 over the rotation sensing element 421 and defining a portion of an exterior surface of the housing. The rotation sensing element 421 may sense the rotation of the outer member 413 through the protective cover 429. For example, the protective cover 429 may be an optically transmissive window such that an optical rotation sensor can sense the rotation of the outer member 413 through the optically transmissive window. Seals (e.g., elastomer members, adhesives, etc.) may be included around the rotation sensing element 421 and/or a protective cover to prevent or limit ingress of liquids, debris, or other contaminants.

The rotation sensing element 421 may be positioned at least partially in an opening 419 in the housing 402 that extends from the interior volume 425 to an exterior of the housing. The rotation sensing element 421 may thus sense the rotation of the outer member 413 through the opening 419. The opening 419 may also allow conductors (e.g., wires, flexible circuit boards, traces, etc.) to pass from the rotation sensing element 421 to sensing circuitry or other components within the housing 402 of the device 400. The rotation sensing element 421 may be positioned in a device in a location or configuration other than that shown in FIG. 4A. For example, a rotation sensing element 421 may be positioned in the device 400 so that it senses rotation of the outer member 413 through an optically transmissive or non-conductive portion of the cover 408.

The crown 412 may include a component that extends into the housing 402 through an opening 417. For example, the inner member 411 may include a shaft portion that extends through the opening 417. A sealing member 420, such as an elastomeric member or other material or component(s), may form a seal between the shaft (or another portion of the inner member 411) and the housing 402 to prevent ingress of liquids, debris, or other contaminants. The sealing member 420 may seal the opening 417 while also allowing the inner member 411 to move relative to the housing 402. For example, while the inner member 411 may be rotationally constrained (e.g., rotationally fixed or partially rotatable), it may still be able to translate axially. As such, the sealing member 420 may seal the opening while allowing the inner member 411 to move axially. In other cases, the inner member 411 may be fixed to the housing 402, such as with adhesive, welds, fusion bonds, or the like. In such cases, the sealing member 420 may be omitted.

The axial translation of the inner member 411, where axial translation is permitted, may facilitate input and output functionalities. For example, the device 400 may include a force sensing component 424 positioned at least partially within the housing 402 and coupled to the inner member 411 (or any other translatable portion of the crown 412). The force sensing component 424 may detect axial forces applied the crown 412 (e.g., forces applied along a direction indicated by arrow 105, FIG. 1A). The axial translation of the inner member 411 may facilitate the detection of the axial force by allowing the inner member 411 to move to deform, deflect, collapse, or otherwise physically affect a force sensing component 424. The force sensing component 424 may be positioned between a fixed support 422 and the inner member 411, such that an axial force applied to the crown 412 compresses the force sensing component 424. Other configurations are also possible.

The force sensing component 424 may be or may include any suitable component(s) for sensing an amount of applied force, including a strain gauge, a piezoelectric component, a piezoresistive component, quantum tunneling materials, a force sensing resistor (FSR), or the like. The force sensing component 424 may be coupled to force sensing circuitry or other components to define a force sensor.

The force sensor (which includes the force sensing component) may determine a magnitude of force associated with an axial force that is applied to the crown 412. If the magnitude of the force is greater than a threshold value, the force sensor may cause the device 400 to perform an action. For example, the force sensor may cause the device to register an input, change a graphical output on a display, change an operational state of the device, or the like. In some cases, the force sensor may cause a haptic actuator (e.g., a haptic actuator 415) to produce a tactile output. The tactile output may act as physical feedback to the user that an input or selection has been registered by the device 400.

The device 400 may also include a haptic actuator 415. The haptic actuator 415 may be coupled to the inner member 411, or any other component of the crown 412, to produce tactile outputs detectable through the crown 412. The haptic actuator 415 may be or may include any suitable components to produce a haptic output, including electrostatic actuators, piezoelectric actuators, oscillating or rotating masses, ultrasonic actuators, reluctance force actuators, voice coil motors, Lorentz force actuators, or the like. Moreover, the haptic actuator 415 may be configured to move the crown 412 along any suitable direction or axis to produce the tactile output, including axially, rotationally (e.g., plus and minus 2 degrees about a neutral position), pivotally, translationally, or the like.

FIG. 4B depicts another example embodiment of the wearable device 400 of FIG. 4A. In FIG. 4B, however, the force sensing component is a dome switch 431. The dome switch 431 may provide both an input detection and a tactile output function. For example, when an axial force exceeding a collapse threshold of the dome switch 431 is applied to the crown 412, the dome switch 431 may abruptly collapse, which both closes an electrical contact (thereby allowing the device to register the input), and produces a tactile “click” or other tactile output that may be felt by the user. Accordingly, the dome switch 431 may be used instead of or in conjunction with a separate force sensor and/or haptic actuator.

FIG. 5 is a partial cross section of an electronic device 500, corresponding to a view along line A-A in FIG. 1B. The device 500 may be an embodiment of the device 100, and may include the same or similar components and may provide the same or similar functions as the device 100 (or any other wearable device described herein). Accordingly, details of the wearable device 100 described above may apply to the device 500, and for brevity will not be repeated here.

Like the devices shown in FIGS. 4A-4B, the device 500 includes a crown 512 positioned along a side of a housing 502. The crown 512 may include an inner member 511 that is rotationally constrained relative to the housing 502, and an outer member 513 that is rotationally free relative to the inner member 511. As shown, the outer member 513 is a sleeve that is positioned around a cylindrical surface of the inner member 811.

The device may include a housing 502, a cover 508, a sealing member 520, a force sensing component 524, a haptic actuator 515, and a fixed support 522, each of which may be the same as or similar to the corresponding components of the device 400, described above. Accordingly, details of those components are equally applicable to the device 500 and for brevity will not be repeated here.

The device 500 may also include a rotation sensing element 514 that, in conjunction with sensing circuitry and/or other components of a rotation sensor, is configured to sense a rotation of the outer member 513 relative to the inner member 511. In the device 500, the rotation sensing element 514 is positioned at least partially within the inner member 511. The rotation sensing element 514 may detect rotation as a surface 523 of the outer member 513 moves past the rotation sensing element 514. As described above with respect to the outer member 413, the outer member 513 may have features or components that facilitate the rotation sensing by the rotation sensing element 514. For example, the outer member 513 may include magnets or ferromagnetic materials to facilitate rotation sensing by a Hall effect sensor, or a pattern of grooves or other features to facilitate rotation sensing by an optical sensor. Such features or components may be positioned along the surface 523 of the outer member 513, or at any other position or location to facilitate sensing by the rotation sensing element 514.

The rotation sensing element 514 may be coupled to sensing circuitry or other components within the interior volume of the housing 502 via a conductor 521 (e.g., a wire, conductive trace, flexible circuit element, etc.). The conductor 521 may be positioned within the inner member 511 (or along a surface of the inner member 511), and may terminate to another conductor along a side of a shaft of the inner member 511. In this way, the rotation sensing element 514 may be coupled to other components of the rotation sensor within the housing 502 without requiring an additional opening in the housing 502.

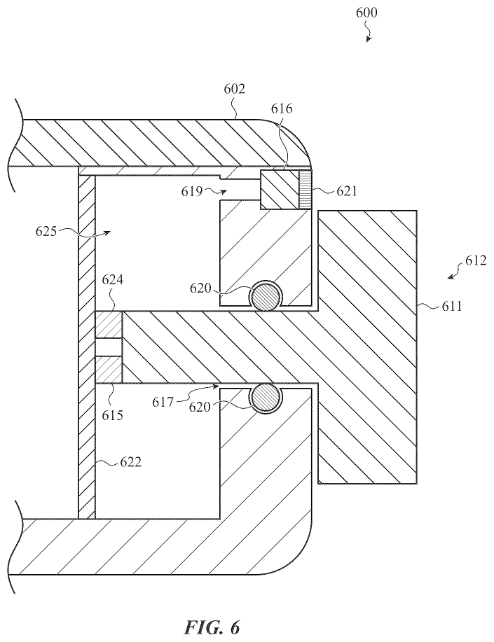

FIG. 6 is a partial cross section of an electronic device 600, corresponding to a view along line A-A in FIG. 1B. The device 600 may be an embodiment of the device 100, and may include the same or similar components and may provide the same or similar functions as the device 100 (or any other wearable device described herein). Accordingly, details of the wearable device 100 described above may apply to the device 600, and for brevity will not be repeated here.

Like the devices shown in FIGS. 4A-5, the device 600 includes a crown 612 positioned along a side of a housing 602. The device may include a cover 608, a sealing member 620, a force sensing component 624, a haptic actuator 615, and a fixed support 622, each of which may be the same as or similar to the corresponding components of the devices 400, 500 described above. Accordingly, details of those components are equally applicable to the device 600 and for brevity will not be repeated here.

FIGS. 4A-5 show crowns in which at least one component is rotationally free, and where the rotation of the rotationally free member is sensed in order to detect inputs applied to the crown. FIG. 6 includes a crown 612 that includes a rotationally constrained member 611 (e.g., a rotationally fixed or partially rotatable member) and a sensing element 616 that is configured to detect the movement of a user's finger (or other object or implement), rather than the rotation of a crown component. More particularly, as described above, when a user interacts with the rotationally constrained member 611 of the crown by attempting to spin or rotate the crown (which may be an intuitive way to interact with the crown 612), the user's fingers may simply slide along a surface of the rotationally constrained member 611, as the rotationally constrained member 611 cannot continuously rotate in response to the applied force. Accordingly, although there is no continuous rotation to sense, the motion of the user's finger may be indicative of the input that the user is applying to the crown 612. For example, the speed and/or direction of the motion of the user's finger may be used to control the operation of the device 600 in a manner similar to the speed and/or direction of a rotation of a crown.

In order to detect the movement of the user's finger as it slides along a surface of the crown 612 (e.g., a surface of the rotationally constrained member 611), the device 600 may include a sensing element 616. The sensing element may be coupled to the housing 602 and may be positioned in a location where a finger is likely to be within a sensing distance from the sensing element 616 when the user is interacting with the crown 612. For example, due to the location of the crown 612, a user's finger (either an index finger as shown in FIGS. 2A-3B or a thumb, such as when a user is applying a twisting gesture with a thumb and index finger) may be proximate the sensing element 616 when the user is interacting with the crown 612. Accordingly, the sensing element 616 may be able to sense the movement of the user's finger in all or most use conditions. In some cases, multiple sensing elements are positioned at different locations proximate the crown 612 to help detect finger movement under different use conditions. Such multiple sensing elements may be positioned at various locations around the crown 612, such as above, below, to the left, and to the right of the crown 612.

The sensing element 616 may use any suitable type of sensing technology or technique, including those described herein with respect to FIGS. 11A-11D. For example, the sensing element 616 may be or may be part of an optical sensor, a capacitive sensor, a resistive sensor, an inductive sensor, or any other suitable type of sensor. In some cases, the sensing element 616 may be part of or integrated with a touch sensor that is used to detect touch inputs applied to an input surface defined by the cover 608. More particularly, as noted above, a wearable device may include a touch sensor associated with a display to produce a touch-screen style display. The touch sensor of the display may be configured so that some of the sensing elements (e.g., capacitive sense pixels) are sufficiently close to the crown 612 to detect a user's finger when the user's finger is sliding along a surface of the crown 612. The sensing elements may be additional sensing elements that are dedicated to detecting finger movements associated with crown manipulations, or they may be sensing elements that are also used to detect touch inputs applied to a user input surface associated with the display.

The sensing element 616 is configured to sense movement of a user's finger or other object that is entirely outside of the interior volume 625 of the device 600. The device 600 may also include a protective cover 621 over the sensing element 616 and defining a portion of an exterior surface of the housing. The sensing element 616 may sense the movement of the user's finger through the protective cover 621. For example, the protective cover 621 may be an optically transmissive window such that an optical sensor can sense the movement of the user's finger through the optically transmissive window. Seals (e.g., elastomer members, adhesives, etc.) may be included around the sensing element 616 and/or a protective cover to prevent or limit ingress of liquids, debris, or other contaminants.

The sensing element 616 may be positioned at least partially in an opening 619 in the housing 602 that extends from the interior volume 625 to an exterior of the housing. The sensing element 616 may thus sense movement of a user's finger (or other implement or object such as a stylus) through the opening 619. The opening 619 may also allow conductors (e.g., wires, flexible circuit boards, traces, etc.) to pass from the sensing element 616 to sensing circuitry or other components within the housing 602 of the device 600.

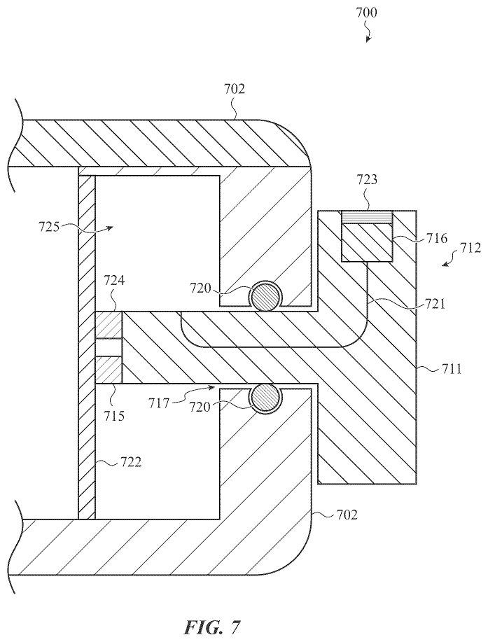

FIG. 7 is a partial cross section of an electronic device 700, corresponding to a view along line A-A in FIG. 1B. The device 700 may be an embodiment of the device 100, and may include the same or similar components and may provide the same or similar functions as the device 100 (or any other wearable device described herein). Accordingly, details of the wearable device 100 described above may apply to the device 700, and for brevity will not be repeated here.

Like the device shown in FIGS. 4A-6, the device 700 includes a crown 712 positioned along a side of a housing 702. The device may include a cover 708, a sealing member 720, a force sensing component 724, a haptic actuator 715, and a fixed support 722, each of which may be the same as or similar to the corresponding components of the devices 400, 500, 600 described above. Accordingly, details of those components are equally applicable to the device 700 and for brevity will not be repeated here.

FIG. 7 includes a crown 712 that includes a rotationally constrained member 711 (e.g., a rotationally fixed or partially rotatable member) and a sensing element 716 that is configured to detect the movement of a user's finger (or other object or implement) as it slides over a surface of the crown 712. Instead of positioning the sensing element 716 on the housing, as shown in FIG. 6, the device 700 includes the sensing element at least partially within the rotationally constrained member 711 of the crown 712. The sensing element 716 may be configured to detect the motion of a user's finger in the same or a similar manner to the sensing element 616 described with respect to FIG. 6.

The device 700 may also include a protective cover 723 over the sensing element 716 and defining a portion of an exterior surface of the crown 712 (with an outer peripheral surface of the rotationally constrained member 711 defining another portion of the exterior surface of the crown 712). The sensing element 716 may sense the movement of the user's finger through the protective cover 723. For example, the protective cover 723 may be an optically transmissive window such that an optical sensor can sense the movement of the user's finger through the optically transmissive window. Seals (e.g., elastomer members, adhesives, etc.) may be included around the sensing element 716 and/or the protective cover to prevent or limit ingress of liquids, debris, or other contaminants.

The sensing element 716 and/or the protective cover 723 may extend any distance around the circumference of the rotationally constrained member 711. For example, the sensing element 716 and/or the protective cover 723 may extend around the entire circumference of the rotationally constrained member 711, or it may extend less than the complete circumference.

The sensing element 716 may be coupled to sensing circuitry or other components within the interior volume of the housing 702 via a conductor 721 (e.g., a wire, conductive trace, flexible circuit element, etc.). The conductor 721 may be positioned within the rotationally constrained member 711 (or along a surface of the member 711), and may terminate to another conductor along a side of a shaft of the member 711. In this way, the sensing element 716 may be coupled to other components of the sensor within the housing 702 without requiring an additional opening in the housing 702.

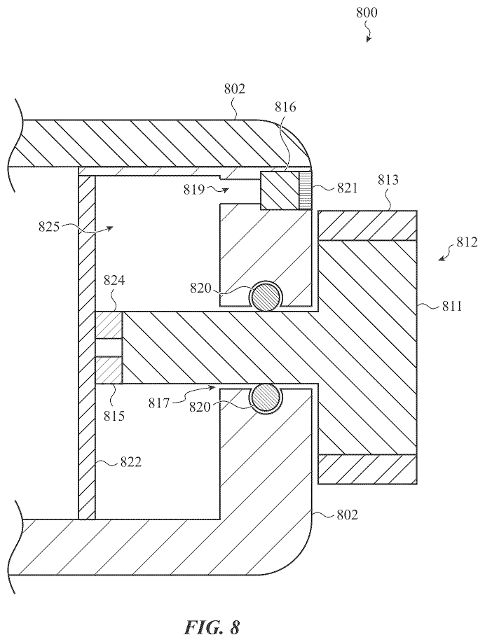

FIG. 8 is a partial cross section of an electronic device 800, corresponding to a view along line A-A in FIG. 1B. The device 800 may be an embodiment of the device 100, and may include the same or similar components and may provide the same or similar functions as the device 100 (or any other wearable device described herein). Accordingly, details of the wearable device 100 described above may apply to the device 800, and for brevity will not be repeated here.

Like the device shown in FIGS. 4A-7, the device 800 includes a crown 812 positioned along a side of a housing 802. The device may include a cover 808, a sealing member 820, a force sensing component 824, a haptic actuator 815, and a fixed support 822, each of which may be the same as or similar to the corresponding components of the devices 400, 500, 600, 700 described above. Accordingly, details of those components are equally applicable to the device 800 and for brevity will not be repeated here.

The crown 812 may include an inner member 811 that is rotationally constrained relative to the housing 802, and an outer member 813 that is rotationally free relative to the inner member 811. As shown, the outer member 813 is a sleeve that is positioned around a cylindrical surface of the inner member 811.

Instead of (or in addition to) detecting the rotation of the rotationally free outer member 813 to control the operation of the device 800, the device 800 uses a sensing element 816 (which may be covered by a protective cover 821) that senses motion of a user's finger as the finger is rotating the outer member 813. In this case, the rotation of the outer member 813 may provide a familiar sensation of physical rotation to the user, but the rotation may not be used for actual detection or sensing of the input.

The inner member 811 and the outer member 813 of the device 800 may be the same as or similar to the inner and outer members of the devices 400 and 500, and the sensing element 816 and protective cover 821 may be the same as or similar to the sensing element 616 and protective cover 621 of the device 600. In some cases, the sensing element 816 may be part of or integrated with a touch sensor associated with a touch-sensitive display, as described above. Accordingly, details of those components are equally applicable to the device 800 and for brevity will not be repeated here.

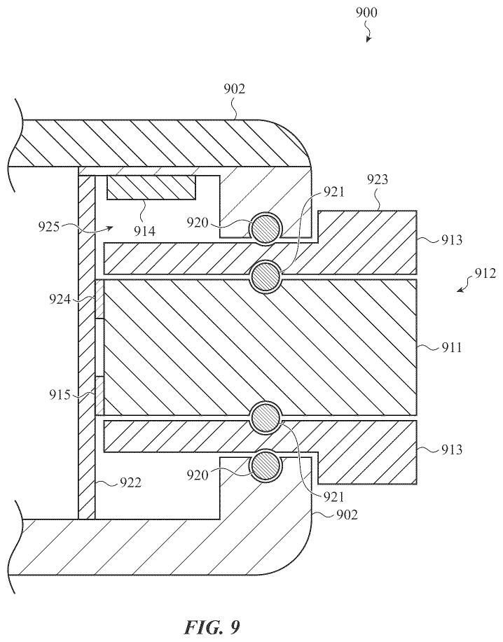

FIG. 9 is a partial cross section of an electronic device 900, corresponding to a view along line A-A in FIG. 1B. The device 900 may be an embodiment of the device 100, and may include the same or similar components and may provide the same or similar functions as the device 100 (or any other wearable device described herein). Accordingly, details of the wearable device 100 described above may apply to the device 900, and for brevity will not be repeated here.

Like the device shown in FIGS. 4A-8, the device 900 includes a crown 912 positioned along a side of a housing 902. The device may include a cover 908, a force sensing component 924, a haptic actuator 915, and a fixed support 922, each of which may be the same as or similar to the corresponding components of the devices 400, 500, 600, 700, 800 described above. Accordingly, details of those components are equally applicable to the device 900 and for brevity will not be repeated here.

The crown 912 may include an inner member 911 that is rotationally constrained relative to the housing 902, and an outer member 913 that is rotationally free relative to the inner member 811. The outer member 913 may include a first portion 923 that is outside (e.g., external to) the housing 902 and defines an input surface of the crown 912. For example, the first portion 923 may define a substantially circular peripheral surface that a user may grasp or touch to rotate when providing an input to the device 900 via the crown 912. The outer member 913 may also include a shaft portion 927 that extends into the interior volume 925 of the device 900. The device 900 may include bearings, bushings, or other components that facilitate the rotation of the outer member 913. For example, the device 900 may include a bearing or bushing or other rolling or sliding component between the housing 902 and the outer member 913, and between the outer member 913 and the inner member 911.

Because the shaft portion 927 rotates in conjunction with the first portion 923, a rotation sensing element 914 within the housing 902 may, in conjunction with rotation sensing circuitry, sense the rotation of the outer member 913 by sensing the rotation of the shaft portion 927. The rotation sensing element 914 may use any suitable type of sensing technology or technique, including those described herein with respect to FIGS. 11A-11D. For example, the rotation sensing element 914 may be or may be part of an optical sensor, a capacitive sensor, a resistive sensor, an inductive sensor, or any other suitable type of sensor.

The device 900 may also include a first sealing member 920 between the housing 902 and the outer member 913, and a second sealing member 921 between the outer member 913 and the inner member 911. The sealing members 920, 921, which may be elastomeric members or other suitable material or component(s), may prevent or reduce the ingress of liquids, debris, or other contaminants. The sealing members 920, 921 may seal the openings between the housing 902, outer member 913, and inner member 911 while also allowing the outer member 913 to rotate relative to the inner member 911, and while allowing both the inner and outer members 911, 913 to translate relative to the housing 902. For example, while the inner member 911 may be rotationally constrained (e.g., rotationally fixed or partially rotatable), it may still be able to translate axially. The outer member 913 may also be able to translate axially along with the inner member 911, and may in fact be coupled to the inner member 911 such that an axial force applied to either the inner member or the outer member may cause both the inner member 911 and the outer member 913 to translate axially. As such, the sealing members 920, 921 may seal the openings between the various components while allowing the outer member 913 to translate axially and to rotate, and while allowing the inner member 911 to translate axially.

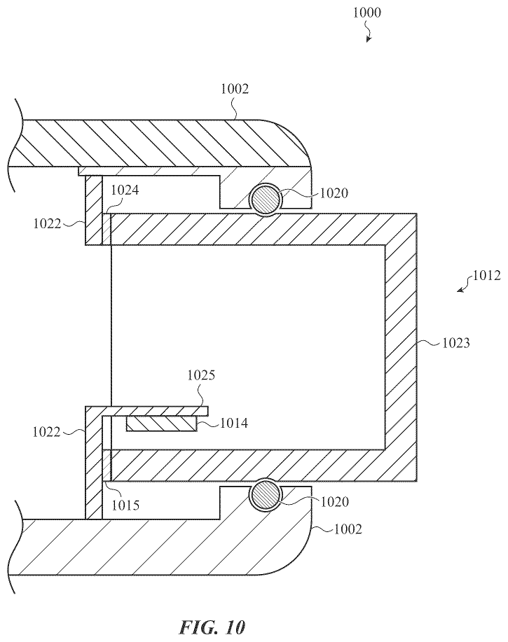

FIG. 10 is a partial cross section of an electronic device 1000, corresponding to a view along line A-A in FIG. 1B. The device 1000 may be an embodiment of the device 100, and may include the same or similar components and may provide the same or similar functions as the device 100 (or any other wearable device described herein). Accordingly, details of the wearable device 100 described above may apply to the device 1000, and for brevity will not be repeated here.

Like the device shown in FIGS. 4A-9, the device 1000 includes a crown 1012 positioned along a side of a housing 1002. The device may include a cover 1008, a force sensing component 1024, a haptic actuator 1015, and a fixed support 1022, each of which may be the same as or similar to the corresponding components of the devices 400, 500, 600, 700, 800, 900 described above. Accordingly, details of those components are equally applicable to the device 1000 and for brevity will not be repeated here.

The crown 1012 may include a rotatable member 1023 that is configured to rotate relative to the housing 1002. Bearings, bushings, or other components may be used between the rotatable member 1023 and the housing 1002 to facilitate the rotation of the rotatable member 1023 in response to a rotating force applied by a user. Further, the device 1000 may include a sealing member 1020 between the rotatable member 1023 and the housing 1002. The sealing member 1020, which may be elastomeric members or any other suitable material or component(s), may prevent or reduce the ingress of liquids, debris, or other contaminants into the device 1000. The sealing member 1020 may seal the opening between the housing 1002, rotatable member 1023, while also allowing the rotatable member 1023 to rotate and optionally translate axially relative to the housing 1002.

The device 1000 may also include a rotation sensing element 1014 that, along with rotation sensing circuitry and/or other components, senses rotation of the rotatable member 1023. For example, the rotation sensing element 1014 may sense the rotation of an inner wall 1027 of the rotatable member 1023 (or any other portion of the rotatable member 1023. The rotation sensing element 1014 may use any suitable type of sensing technology or technique, including those described herein with respect to FIGS. 11A-11D. For example, the rotation sensing element 1014 may be or may be part of an optical sensor, a capacitive sensor, a resistive sensor, an inductive sensor, or any other suitable type of sensor.

As noted above, the sensors and/or sensing elements that sense either rotation of a crown component and/or motion of a user's finger (or other object or implement) may use any suitable sensing technology or technique. FIGS. 11A-11D illustrate example sensors that use various techniques to sense motion of an object (e.g., either rotation of a crown component or movement of a user's finger). These example sensors may be used in any of the devices described herein.

FIG. 11A shows an optical sensing element 1100 to sense movement of an object 1109. The object 1109 may be a user's finger, a stylus, a rotatable component of a crown, or the like. The object 1109 may be moving relative to the sensing element 1100 along a direction indicated by arrow 1107, which may correspond to a movement of a user's finger (e.g., a translational movement), or a rotation of a rotating component of a crown.

The optical sensing element 1100 includes a light emitter 1102 and a light detector 1104. The light emitter may emit light 1106 (e.g., visible light, laser light, ultraviolet light, non-visible light, or the like) towards the object 1109. The light detector 1104 receives light 1108 that is reflected by the object 1109 and may sense a speed and/or direction of motion of the object 1109 using detected properties of the received light (e.g., an intensity of the receive light, an angle of the received light, an amount of received light, a change in a property of the light, etc.) or images of the object 1109 that are captured by the light detector 1104. The light detector 1104 may include an image sensor or any other suitable light sensing components.

The object 1109 may have features that facilitate the sensing of the motion of the object 1109. For example, in cases where the object 1109 is a rotatable member of a crown, the features may include grooves, scratches, graphical patterns, bumps, cavities, or the like. Such features may affect the way that the object 1109 reflects light, which may facilitate detection of the movement of the object 1109 by the light detector 1104. In cases where the object 1109 is a finger, the features may be the natural textures of skin.

FIG. 11B shows another example optical sensor that includes a light detector 1110 (which may include an image sensor or other light sensing components) that detects reflected ambient light. For example, ambient light 1116 may be reflected by the object 1119 as the object 1119 moves along a direction indicated by arrow 1117, and the light detector 1110 may detect a property of the reflected light 1118 and/or capture images of the object 1119 (illuminated by the ambient light 1116) to sense a speed and/or direction of motion of the object 1119. The sensed speed and/or direction of motion of the object 1119 may then be used to control an operation of the device.

FIG. 11C shows a Hall effect sensor 1120 that may be used to sense changes in a magnetic field produced by motion of an object 1129 (e.g., along a direction 1127). The object 1129 may include magnetic and/or ferromagnetic components 1128 that move relative to the Hall effect sensor 1120 to facilitate the sensing of the motion of the object 1129.

FIG. 11D shows a capacitive sensing element 1130. The capacitive sensing element 1130 may use multiple capacitive sense pixels 1132, 1134 to detect motion of an object 1139. For example, as the object 1139 (e.g., a user's finger) approaches the first capacitive sense pixel 1132, the object 1139 causes a change in capacitance that is detected by the first capacitive sense pixel 1132. As the object 1139 continues to move along the direction 1137, it approaches the second capacitive sense pixel 1134 and causes a change in capacitance that is detected by the second capacitive sense pixel 1134. The change in capacitance detected by the first and second capacitive sense pixels (and optionally additional capacitive sense pixels) as the object 1139 moves may together be used to determine a speed and/or direction of motion of the object 1139, which may in turn be used to control an operation of a device. Where capacitive sense pixels are used to sense motion of an object, they may be part of a sensor that is solely used to sense motion of a finger as it interacts with a crown. In other cases, the capacitive sense pixels may be part of a touch sensor that is also used to detect touch inputs on a touch-screen display, as described above.

FIG. 12 depicts an example schematic diagram of an electronic device 1200. By way of example, the device 1200 of FIG. 12 may correspond to the wearable electronic device 100 shown in FIGS. 1A-1B (or any other wearable electronic device described herein). To the extent that multiple functionalities, operations, and structures are disclosed as being part of, incorporated into, or performed by the device 1200, it should be understood that various embodiments may omit any or all such described functionalities, operations, and structures. Thus, different embodiments of the device 1200 may have some, none, or all of the various capabilities, apparatuses, physical features, modes, and operating parameters discussed herein.

As shown in FIG. 12, a device 1200 includes a processing unit 1202 operatively connected to computer memory 1204 and/or computer-readable media 1206. The processing unit 1202 may be operatively connected to the memory 1204 and computer-readable media 1206 components via an electronic bus or bridge. The processing unit 1202 may include one or more computer processors or microcontrollers that are configured to perform operations in response to computer-readable instructions. The processing unit 1202 may include the central processing unit (CPU) of the device. Additionally or alternatively, the processing unit 1202 may include other processors within the device including application specific integrated chips (ASIC) and other microcontroller devices.

The memory 1204 may include a variety of types of non-transitory computer-readable storage media, including, for example, read access memory (RAM), read-only memory (ROM), erasable programmable memory (e.g., EPROM and EEPROM), or flash memory. The memory 1204 is configured to store computer-readable instructions, sensor values, and other persistent software elements. Computer-readable media 1206 also includes a variety of types of non-transitory computer-readable storage media including, for example, a hard-drive storage device, a solid-state storage device, a portable magnetic storage device, or other similar device. The computer-readable media 1206 may also be configured to store computer-readable instructions, sensor values, and other persistent software elements.

In this example, the processing unit 1202 is operable to read computer-readable instructions stored on the memory 1204 and/or computer-readable media 1206. The computer-readable instructions may adapt the processing unit 1202 to perform the operations or functions described above with respect to FIGS. 1A-11D. In particular, the processing unit 1202, the memory 1204, and/or the computer-readable media 1206 may be configured to cooperate with a sensor 1124 (e.g., a rotation sensor that senses rotation of a crown component or a sensor that senses motion of a user's finger) to control the operation of a device in response to an input applied to a crown of a device (e.g., the crown 112). The computer-readable instructions may be provided as a computer-program product, software application, or the like.

As shown in FIG. 12, the device 1200 also includes a display 1208. The display 1208 may include a liquid-crystal display (LCD), organic light emitting diode (OLED) display, LED display, or the like. If the display 1208 is an LCD, the display 1208 may also include a backlight component that can be controlled to provide variable levels of display brightness. If the display 1208 is an OLED or LED type display, the brightness of the display 1208 may be controlled by modifying the electrical signals that are provided to display elements. The display 1208 may correspond to any of the displays shown or described herein.

The device 1200 may also include a battery 1209 that is configured to provide electrical power to the components of the device 1200. The battery 1209 may include one or more power storage cells that are linked together to provide an internal supply of electrical power. The battery 1209 may be operatively coupled to power management circuitry that is configured to provide appropriate voltage and power levels for individual components or groups of components within the device 1200. The battery 1209, via power management circuitry, may be configured to receive power from an external source, such as an AC power outlet. The battery 1209 may store received power so that the device 1200 may operate without connection to an external power source for an extended period of time, which may range from several hours to several days.

In some embodiments, the device 1200 includes one or more input devices 1210. An input device 1210 is a device that is configured to receive user input. The one or more input devices 1210 may include, for example, a push button, a touch-activated button, a keyboard, a keypad, or the like (including any combination of these or other components). In some embodiments, the input device 1210 may provide a dedicated or primary function, including, for example, a power button, volume buttons, home buttons, scroll wheels, and camera buttons. Generally, a touch sensor or a force sensor may also be classified as an input device. However, for purposes of this illustrative example, the touch sensor 1220 and a force sensor 1222 are depicted as distinct components within the device 1200.

The device 1200 may also include a sensor 1124 that detects inputs provided by a user to a crown of the device (e.g., the crown 112). As described above, the sensor 1124 may include sensing circuitry and other sensing elements that facilitate sensing of rotational motion of a crown component and/or motion of a user's finger that is sliding along a surface of a crown. The sensor 1124 may correspond to the sensors described with respect to FIGS. 11A-11D, or other sensors that may be used to provide the sensing functions described herein.

The device 1200 may also include a touch sensor 1220 that is configured to determine a location of a touch on a touch-sensitive surface of the device 1200 (e.g., an input surface defined by the portion of a cover 108 over a display 109). The touch sensor 1220 may use or include capacitive sensors, resistive sensors, surface acoustic wave sensors, piezoelectric sensors, strain gauges, or the like. In some cases the touch sensor 1220 associated with a touch-sensitive surface of the device 1200 may include a capacitive array of electrodes or nodes that operate in accordance with a mutual-capacitance or self-capacitance scheme. The touch sensor 1220 may be integrated with one or more layers of a display stack (e.g., the display 109) to provide the touch-sensing functionality of a touchscreen. Moreover, the touch sensor 1220, or a portion thereof, may be used to sense motion of a user's finger as it slides along a surface of a crown, as described herein.

The device 1200 may also include a force sensor 1222 that is configured to receive and/or detect force inputs applied to a user input surface of the device 1200 (e.g., the display 109). The force sensor 1222 may use or include capacitive sensors, resistive sensors, surface acoustic wave sensors, piezoelectric sensors, strain gauges, or the like. In some cases, the force sensor 1222 may include or be coupled to capacitive sensing elements that facilitate the detection of changes in relative positions of the components of the force sensor (e.g., deflections caused by a force input). The force sensor 1222 may be integrated with one or more layers of a display stack (e.g., the display 109) to provide force-sensing functionality of a touchscreen.

The device 1200 may also include a communication port 1228 that is configured to transmit and/or receive signals or electrical communication from an external or separate device. The communication port 1228 may be configured to couple to an external device via a cable, adaptor, or other type of electrical connector. In some embodiments, the communication port 1228 may be used to couple the device 1200 to an accessory, including a dock or case, a stylus or other input device, smart cover, smart stand, keyboard, or other device configured to send and/or receive electrical signals.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings. Also, when used herein to refer to positions of components, the terms above and below, or their synonyms, do not necessarily refer to an absolute position relative to an external reference, but instead refer to the relative position of components with reference to the figures.

What is claimed is:

1. An electronic watch, comprising:
a housing;
a display positioned at least partially within the housing;
a cover covering at least part of the display;
a crown having a portion positioned along a side of the housing and comprising:
an inner member that is rotationally constrained relative to the housing; and
an outer member that is rotationally free relative to the inner member; and
a rotation sensor configured to sense a rotation of the outer member relative to the inner member.

2. The electronic watch of claim 1, wherein:
the housing defines an interior volume;
the inner member defines an exterior portion;
the exterior portion of the inner member defines a circular peripheral surface;
the outer member is coupled to the exterior portion of the inner member and is configured to rotate along the circular peripheral surface; and
the outer member is positioned outside the interior volume such that the rotation of the outer member occurs outside the interior volume.

3. The electronic watch of claim 1, wherein the rotation sensor is at least partially within the inner member of the crown.

4. The electronic watch of claim 1, wherein:
the housing defines:
an interior volume; and
an opening extending from the interior volume to an exterior of the housing; and
the rotation sensor is configured to sense the rotation of the outer member through the opening.

5. The electronic watch of claim 4, wherein:
the rotation sensor is an optical sensor;
the electronic watch further comprises an optically transmissive window covering at least part of the opening; and
the rotation sensor senses the rotation of the outer member through the optically transmissive window.

6. The electronic watch of claim 1, further comprising a force sensing component positioned at least partially within the housing and configured to detect an axial force applied to the crown.

7. The electronic watch of claim 6, wherein the force sensing component comprises a dome switch.

8. The electronic watch of claim 1, wherein:
the rotation sensor comprises:
a light emitter configured to emit light toward the outer member of the crown; and
a light detector; and
the light detector is configured to detect the light after the light is reflected by the outer member of the crown.

9. A wearable electronic device, comprising:
a housing;
a display positioned at least partially within the housing;
a cover covering at least part of the display and defining a front face of the wearable electronic device;
a crown positioned along a side of the housing and rotationally constrained relative to the housing; and
a sensor configured to sense a movement of a finger as the finger is sliding along a surface of the crown.

10. The wearable electronic device of claim 9, wherein the crown is rotationally fixed.

11. The wearable electronic device of claim 9, wherein a sensing element of the sensor is positioned at least partially within the crown.

12. The wearable electronic device of claim 11, wherein:
the crown defines a first portion of a surface; and
the crown includes a protective cover covering the sensing element and defining a second portion of the surface.

13. The wearable electronic device of claim 12, wherein:
the sensing element is an optical sensing element; and
the protective cover is an optically transmissive window.

14. The wearable electronic device of claim 9, wherein:
the display defines an output region;
the cover defines an input surface that covers the output region; and
the sensor is a touch sensor that extends along the output region and is configured to:
detect touch inputs applied to the input surface; and
sense the movement of the finger sliding along the surface of the crown.

15. A wearable electronic device, comprising:
a housing;
a display positioned at least partially within the housing;
a cover covering at least part of the display and defining a front face of the wearable electronic device;
a crown positioned along a side of the housing and comprising:
an inner member that is rotationally constrained relative to the housing; and
an outer member that is rotationally free relative to the inner member; and
a sensor configured to sense movement of a finger while the finger is rotating the outer member.

16. The wearable electronic device of claim 15, wherein:
the inner member defines a cylindrical surface; and
the outer member is a sleeve positioned around the cylindrical surface.

17. The wearable electronic device of claim 15, wherein the sensor is positioned along a side of the housing.

18. The wearable electronic device of claim 15, further comprising an actuator coupled to the crown and configured to produce a tactile output through the crown.

19. The wearable electronic device of claim 18, further comprising a force sensor configured to detect an axial force applied to the crown.

20. The wearable electronic device of claim 19, wherein:
the force sensor determines a magnitude of the axial force; and
the wearable electronic device causes the actuator to produce the tactile output if the magnitude of the axial force is greater than a threshold value.
